(19) United States
(12) Patent Application Publication
(10) Pub. No.: US 2026/0269739 A1
(43) Pub. Date: Sep. 10, 2026

(54) AC TO DC POWER CONVERSION METHOD AND SYSTEM

(71) Applicant: The Queen's University of Belfast, Belfast (GB)

(72) Inventors: Ahmad ELKHATEB, Belfast (GB); Mohamed ELGENEDY, Belfast (GB)

(21) Appl. No.: 18/876,519

(22) PCT Filed: Jun. 16, 2023
(86) PCT No.: PCT/EP2023/066260

§ 371 Date: Dec. 18, 2024

(30) Foreign Application Priority Data
Jun. 21, 2022 (GB) 2209121.9

(51) Int. Cl. H02M 7/81; H02M 1/00; H02M 1/084; H02M 3/00; H02M 3/158; H02M 3/335

(52) U.S. Cl. CPC H02M 7/217; H02M 1/4258; H02M 3/005; H02M 7/797

(57) ABSTRACT

An AC to DC power conversion system comprises a plurality of switched-mode DC to DC converters. Each converter has a first input terminal for receiving current from an AC power supply, the respective second input terminals of each converter being connected together but not to the neutral point. The output terminals of each converter are connected in parallel to provide a DC output. A controller generates a reference AC current signal depending on the determined DC output voltage and a reference DC voltage, the reference AC current signal being in phase with the AC supply signal. The controller controls the operation of switches on the converters to cause the AC current at the first input terminal to match the reference AC current signal. The controller keeps the DC output voltage at the desired value while assuring unity power factor and sinusoidal currents at the AC input.

### FIELD OF THE INVENTION

This invention relates to electrical power conversion. The invention relates especially to AC to DC electrical power conversion.

### BACKGROUND TO THE INVENTION

In conventional electrical power networks, the generated, transmitted and distributed electrical power comprises 3-phase AC voltage. However, over relatively long distances it can be more economical and efficient to transmit and distribute DC electrical power, in particular High Voltage DC (HVDC) power or Medium Voltage DC (MVDC) power. For example, it is advantageous to convert the AC power generated by off-shore renewable energy generators to DC power, and then to transmit the DC power to shore. Also, there is an emerging need for electrification of transportation and EVs which required DC power for charging.

There are many conventional power converters that can convert from AC to DC, i.e., rectification. However, a rectifier alone is not able to achieve either the AC side requirements of a unity power factor and low injected harmonics, or the DC side requirements of a controlled and isolated DC voltage. Conventionally, conversion from AC to controllable DC voltage is performed in two stages: first the AC voltage is rectified using diode/thyristor bridge rectifier, then a DC-DC converter is utilised to control the voltage level up or down as required. The two stages require a power frequency transformer to isolate the AC and DC sides, and to step up or down the AC voltage. Therefore, the overall system is bulky and inefficient. Alternatively, the bulky transformer can be removed, and small High Frequency (HF) transformers can be provided within the DC-DC converters, which are connected in series/parallel combination to fulfil the power requirements. Challenges facing these types of power converters include the need for bulky electrolytic capacitors and transformers for energy storage and voltage regulation and isolation, respectively. This becomes even more challenging and inefficient when the power and voltage level increased.

Circuit topologies have been devised to address the growing need for more efficient and high-power AC-DC conversion systems. These topologies succeed in producing DC voltage from AC in a single phase, and therefore when extending the conversion to three phases they convert each phase separately and hence require access to the neutral point. This is challenging and not only increases the cable and connection requirements, but also, for example for offshore wind or wave energy turbines, the neutral point is sometimes inaccessible, which limits the applicability of these topologies. Moreover, the need for high capacitance for energy conversion and storage requires electrolytic capacitors, and such capacitors are not stable at high-frequency operations and their lifetime is relatively short. Additionally, known single-stage conversion topologies require a relatively number of semi-conductors per module to achieve the desired rectification.

It would be desirable to provide an improved AC to DC power conversion system and method that mitigate at least some of the problems outlined above.

### SUMMARY OF THE INVENTION

From a first aspect the invention provides an AC to DC power conversion system for converting AC power from an AC power supply to DC power, the conversion system comprising:
a plurality of switched-mode DC to DC converters, each DC to DC converter comprising:
   an input comprising a first input terminal for receiving current from said AC power supply, and a second input terminal;
   an output comprising a first output terminal and a second output terminal;
   at least one energy storage component; and
   at least one controllable switch for controlling operation of the converter,
wherein the respective second input terminal of each converter are connected together, and the respective output terminals of each converter are connected in parallel to provide a DC output;
a controller for controlling operation of said at least one controllable switch of each DC to DC converter;
means for determining a DC voltage at said DC output;
means for determining at least one AC voltage signal received from said AC power supply, said at least one AC voltage signal comprising a single-phase voltage signal or a multi-phase voltage signal; and
means for determining AC current at the first input terminal of at least one of said converters, wherein for each of said converters said controller is configured to
generate a reference AC current signal depending on the determined DC voltage and a reference DC voltage, said reference AC current signal being in phase with said single-phase voltage signal or a respective phase of said multi-phase voltage signal, and
control the operation of said at least one controllable switch to cause the AC current at the first input terminal to match the reference AC current signal.

Preferably, each DC to DC converter comprises a current source DC to DC converter.

Preferably, said at least one energy storage component comprises at least one inductor connected in series with said first input terminal, and preferably at least one capacitor connected in series with said at least one inductor.

Typically, said at least one energy storage component comprises at least one inductor connected in series with said first output terminal or said second output terminal, and preferably at least one capacitor in series with said at least one inductor.

Said at least one energy storage component may comprise at least one capacitor connected in series with said first input terminal, and with said first output terminal or said second output terminal, or at least one capacitor connected in parallel with the converter output.

Optionally, each converter includes a transformer connected between the input and the output to galvanically isolate the input and the output, and wherein, preferably, a respective capacitor is connected to each side of the transformer, preferably in series with the transformer.

In preferred embodiments, each DC to DC converter comprises at least one first inductor connected in series with said first input terminal, at least one second inductor connected in series with said first output terminal or said second output terminal, and at least one capacitor connected in series between said at least one first inductor and said at least one second inductor.

In preferred embodiments, said at least one controllable switch comprises a first controllable switch and a second controllable switch, or a first controllable switch and a diode, and wherein, preferably, said first controllable switch and or second controllable switch, or said first controllable switch and said diode, are connected in parallel with said input and said output, and wherein, preferably, said first controllable switch is connected to an input side of said converter, and said second controllable switch, or said diode, is connected to an output side of said converter.

Typically, said first controllable switch is connected in parallel with said input between said at least one first conductor and said at least one capacitor, and wherein said second controllable switch, or said diode, is connected in parallel with said output between said at least one capacitor and said at least one second conductor.

In preferred embodiments, each DC to DC converter has a Cuk converter topology. Preferably, each DC to DC converter is a bidirectional DC to DC converter.

In preferred embodiments, said controller is configured to generate said reference AC current signal depending on the difference between said determined DC voltage and said reference DC voltage. Preferably, said controller is configured to generate said reference AC current signal by implementing a closed feedback control loop configured to cause said determined DC voltage to match said reference DC voltage, and by using the output of said feedback control loop to generate said reference AC current signal, and wherein said closed feedback control loop is optionally implemented using proportional-integral (PI) control.

In preferred embodiments, said controller is configured to determine a reference current value depending on the determined DC voltage and the reference DC voltage, and to generate said reference AC current signal from said reference current value. Said controller may be configured to determine said reference current value depending on the difference between said determined DC voltage and said reference DC voltage, or said controller may be configured to determine said reference current value from the output of said feedback control loop.

Preferably, said system further includes means for causing said reference AC current signal to be in phase with the single-phase AC voltage signal or with a respective phase of the multi-phase AC voltage signal.

In preferred embodiments, said means for causing said reference AC current signal to be in phase with the single-phase AC voltage signal or with a respective phase of the multi-phase AC voltage signal comprises means for combining said reference current value with a respective per unit version of said single-phase AC voltage signal or with said respective phase of the multi-phase AC voltage signal, or other respective reference signal derived from said single-phase AC voltage signal or from said respective phase of the multi-phase AC voltage signal, and having a waveform that matches the waveform of the single-phase AC voltage signal or of the respective phase of the multi-phase AC voltage signal.

Preferably, said controller is configured to control the operation of said at least one controllable switch to cause said AC current at the first input terminal to match said reference AC current signal depending on the difference between said determined AC current and the respective reference AC current signal. Said controller may be configured to implement a closed feedback control loop configured to cause said determined AC current to match the reference AC current signal, and to use the output of said feedback control loop to control said at least one controllable switch, and wherein said closed feedback control loop is optionally implemented using proportional-integral (PI) control or proportional-resonant (PR) control.

In preferred embodiments, said at least one controllable switch comprises first and second controllable switches, and wherein said controller is configured to control said first and second controllable switches such that when either one of said first and second controllable switches is on, the other of said first and second controllable switches is off.

Optionally, said at least one controllable switch comprises one controllable switch, the converter further including a diode connected in parallel with the controllable switch, the configuration being such that when said controllable switch is on the diode is reverse biased, and when the controllable switch is off the diode is forward biased.

In some embodiments, said AC power supply comprises a multi-phase power supply and said at least one AC voltage signal comprises multiple AC voltage phases, wherein said plurality of DC to DC converters comprises at least one respective DC to DC converter for each phase of the power supply, wherein the respective first input terminal of said at least one respective converter is arranged to receive AC current from the respective phase of the power supply, wherein said means for determining AC current comprises means for determining AC current at the first input terminal of each of said at least one respective converters, said means for determining at least one AC voltage signal comprises means for determining a respective AC voltage signal for each phase, and wherein the controller is configured to generate a respective reference AC current signal for each phase of the power supply. Said at least one respective converter preferably comprises a plurality of said converters connected in parallel with each other. Said means for determining at least one AC voltage signal may comprise means for determining line voltages for said multi-phase supply, and means for determining a respective phase voltage, preferably a respective per-unit phase voltage, for each phase from the line voltages.

In other embodiments, said AC power supply comprises a single-phase power supply and said at least one AC voltage comprises a single phase AC voltage, wherein said plurality of DC to DC converters comprises at least one first DC to DC converter and at least one second DC to DC converter, the first input terminal of said at least one first DC to DC converter being connected to or connectable to a positive terminal of said AC power supply, and the first input terminal of said at least one second DC to DC converter being connected to or connectable to the negative terminal of said AC power supply. Said at least one first DC to DC converter may comprise a plurality of first DC to DC converters connected in parallel with each other, and said at least one second DC to DC converter comprises a plurality of second DC to DC converters connected in parallel with each other.

From a second aspect the invention provides a method of converting AC power from an AC power supply to DC power in a power conversion system comprising:
a plurality of switched-mode DC to DC converters, each DC to DC converter comprising:
   an input comprising a first input terminal for receiving current from said AC power supply, and a second input terminal;
   an output comprising a first output terminal and a second output terminal;
   at least one energy storage component; and
   at least one controllable switch for controlling operation of the converter,
wherein the respective second input terminal of each converter are connected together, and the respective output terminals of each converter are connected in parallel to provide a DC output, the method comprising:
determining a DC voltage at said DC output;
determining at least one AC voltage signal received from said AC power supply, said at least one AC voltage signal comprising a single-phase voltage signal or a multi-phase voltage signal;
determining AC current at the first input terminal of at least one of said converters;
generating, for each converter, a reference AC current signal depending on the determined DC voltage and a reference DC voltage, said reference AC current signal being in phase with said single-phase voltage signal or a respective phase of said multi-phase voltage signal; and
controlling the operation of said at least one controllable switch of each converter to cause the AC current at the first input terminal to match the reference AC current signal.

In preferred embodiments, the AC to DC power conversion system comprises a plurality of switched-mode DC to DC converters. Each converter has a first input terminal for receiving current from an AC power supply, the respective second input terminals of each converter being connected together but not to the neutral point or other reference voltage. The output terminals of each converter are connected in parallel to provide a DC output. A controller generates a reference AC current signal depending on the determined DC output voltage and a reference DC voltage, the reference AC current signal being in phase with the AC supply signal. The controller controls the operation of switches on the converters to cause the AC current at the first input terminal to match the reference AC current signal.

In preferred embodiments, the AC to DC power conversion system provides single-stage AC-DC power conversion, advantageously using an electronic power converter topology that is scalable, modular and advantageously also redundant.

Embodiments of the invention are particularly, but not exclusively, suited for performing Medium Voltage (MV) single-stage AC-DC power conversion. For example, embodiments of the invention may be used to connect Medium Voltage AC (MVAC) and Medium Voltage DC (MVDC) grids, networks or systems, for example in applications such as offshore wind farms (or other offshore renewable energy generation farms) and electric vehicle (EV) chargers, and/or more generally in power grid distribution systems operating with MVDC, which are envisaged as the future of smart, efficient, and resilient power grids.

In preferred embodiments, the power converter(s) in conjunction with the preferred control method enable AC to DC power conversion for three-phase balanced systems, even where access to the neutral point of the AC power is impaired. In use, the power converter(s) may be connected to a three-phase AV voltage source that provides no access to the neutral point since neutral point access is not required (for example the neutral point is typically inaccessible in MVAC or HVAC systems, to which, for example, most offshore wind turbines, other renewable energy turbines and level-3 EV chargers are connected. Since the power converter(s) are advantageously not connected to the neutral point (or other voltage point), they may be described as floating. In preferred embodiments, the AC to DC power conversion system comprises a floating single-stage bridgeless AC to DC power converter.

In preferred embodiments, the received AC voltage is converted to a stepped-up (or stepped down if required) controlled DC voltage. This may be achieved using one or more DC-DC power converter (preferably in the form of modified Cuk power converter(s)). The number of DC-DC power converters per phase may be varied depending on the desired power and voltage levels. Hence, the power converter(s) are advantageously modular (which allows scalability and redundancy) and can be used to target any desired power/voltage level. Moreover, embodiments of the invention can be used in single-phase systems. Optionally, the AC side and DC side of the power converter can be (galvanically) isolated by incorporation of one or more transformer, in particular HF transformer(s).

In preferred embodiments, the power converter(s) use electrolytic free capacitors, which not only improve the converter operation but also increase its lifetime. Advantageously, in preferred embodiments, bulky energy storage capacitors and the power frequency transformer for voltage regulation and isolation are avoided. Instead, in preferred embodiments, each power converter includes distributed, relatively small, passive energy storage elements, i.e. one or more inductor and/or one or more capacitor, with the option of adding one or more HF transformer for isolation purposes if necessary.

Advantageously, the preferred control method keeps the DC voltage at the output at the desired value while assuring unity power factor and sinusoidal, or substantially sinusoidal, currents at the AC input. Advantageously, embodiments of the invention are implemented using a high power density topology, i.e. reduced silicon area, and electrolytic free capacitors.

In preferred embodiments, the control method aims to control the converters in a manner that provide the following features: controllable DC output voltage; unity input power factor; output voltage boosting; and bridgeless operation, preferably with electrolytic free requirement.

Preferred embodiments of the invention include or exhibit any one or more of the following features:
Modular design: allowing scalability, and fault-tolerant operation may be obtained by introducing redundant modules.
Floating design: no access to the three-phase system neutral point is required.
Single-stage conversion: no rectifier bridges are required, and fewer stages leads to higher efficiency.
Applicable to multi-phase or single-phase AC power systems.
Ability to work at high switching frequencies; hence, wide-band-gap devices can be used and isolation high-frequency transformers.
Unity power factor operation: hence the reactive power is nullified, and active power transfer capability increased.
Unlike the existing single-stage topologies, only two switches isolated at the same voltage level are required for each modified Cuk converter module: hence, no gate signal firing complications and more efficient operation.
High gain with minimal filtering effort; continuous current operation at both the AC and DC side is supported.

Further advantageous aspects of the invention will be apparent to those ordinarily skilled in the art upon review of the following description of specific embodiments and with reference to the accompanying drawings.

### BRIEF DESCRIPTION OF THE DRAWINGS

Embodiments of the invention are now described by way of example and with reference to the accompanying drawings in which like numerals are used to denote like parts and in which:

FIG. 1 is a block diagram of an AC to DC power conversion system embodying the invention, the system being suitable for use with a multi-phase power supply;

FIG. 2 is a circuit diagram of a preferred converter for use in the system of FIG. 1;

FIG. 3 is a circuit diagram of an alternative, galvanically isolated, converter for use in the system of FIG. 1;

FIG. 4 is a block diagram of an alternative embodiment of the power conversion system, in which a plurality of instances of converter are provided for each phase of the power supply;

FIG. 5 is a circuit diagram illustrating a preferred implementation of the system of FIG. 1;

FIG. 6 is a schematic diagram illustrating a preferred controller or control method for the system of FIGS. 1 and 5;

FIG. 7 is a block diagram of an alternative embodiment of the power conversion system suitable for use with a single phase power supply;

FIG. 8 is a circuit diagram illustrating a preferred implementation of the system of FIG. 7; and

FIG. 9 is a schematic diagram illustrating a preferred controller or control method for the system of FIGS. 7 and 8.

### DETAILED DESCRIPTION OF THE DRAWINGS

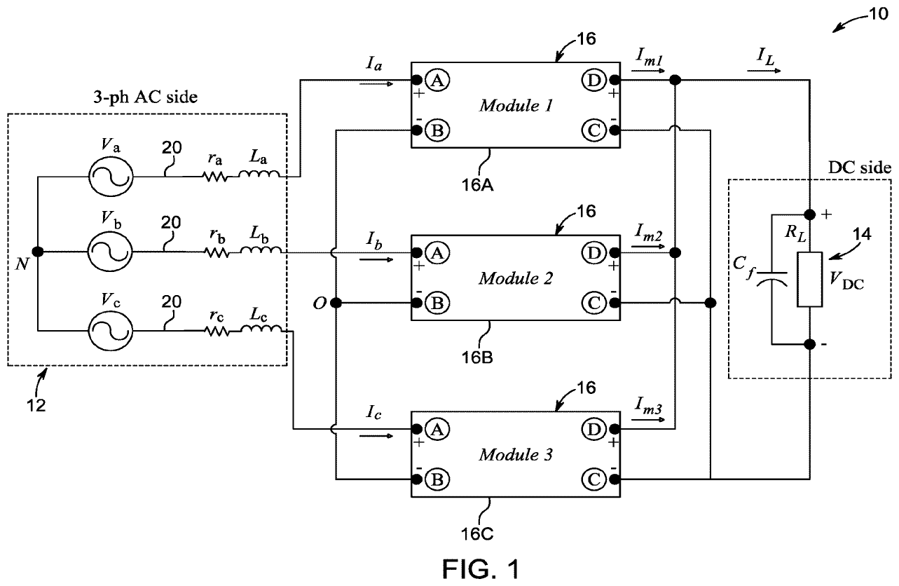

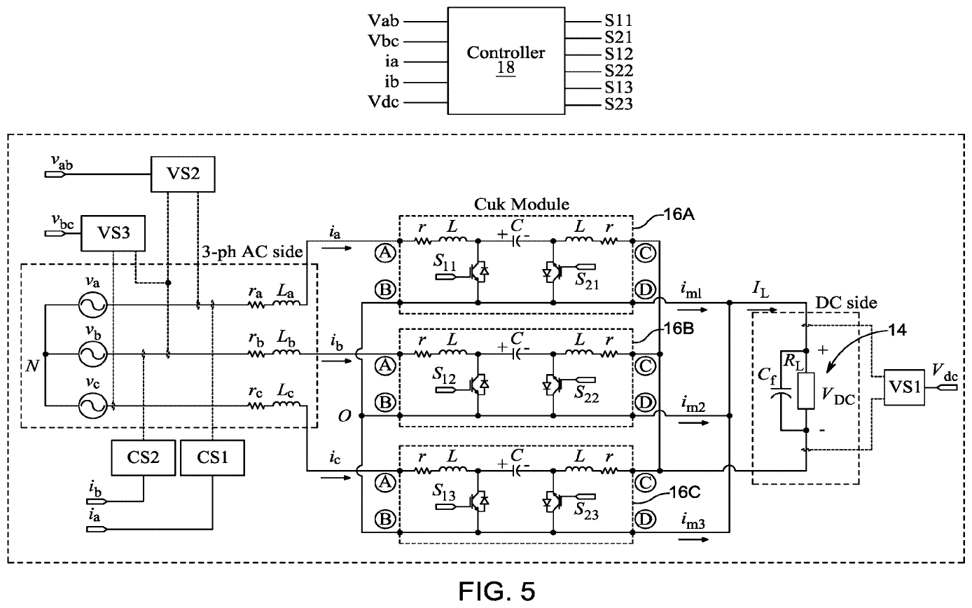

FIG. 1 of the drawings shows, generally indicated as 10, an exemplary AC to DC power conversion system embodying one aspect of the invention. The system 10 has an electrical power input that is connected to, or is connectable to, a 3-phase AC electrical power supply 12, and an electrical power output that is connected to, or is connectable to a DC load 14. The system 10 comprises a plurality of power converters 16 for converting 3-phase AC voltage (Va, Vb, Vc) from the power supply 12 at the input into DC voltage (V_{DC}) at the output. In the embodiment of FIG. 1, a respective power converter 16A, 16B, 16C is provided for each phase of the power supply 12. The system 10 also includes a controller (not shown in FIG. 1 but shown in FIG. 5 as 18) for controlling operation of the power converters 16 as is described in more detail hereinafter. The controller may take any suitable conventional form, for example a suitably programmed or configured processor (e.g. microprocessor or digital signal processor), comprising hardware and/or software as applicable.

Conventionally, the phases of a 3-phase AC power supply are connected to each other either in a star connection or in a delta connection. In either case a respective supply line (commonly referred to as a wire) is provided for each phase. In the case of the star connection, the phases are connected together at a common point, which may be referred to as the neutral point, and a fourth wire (commonly referred to as the neutral wire) may be connected to the neutral point. The 4-wire system (i.e. 3 phase wires and a neutral wire) is commonly used in Low Voltage (LV) parts of an electrical power system (which are typically at the distribution part of the system) whereby respective loads can be supplied by a respective phase wire and the neutral wire. The neutral wire provides a current path when the respective phase loads are unbalanced.

In applications where the phase loads are balanced, the neutral wire can be omitted. For example, in the Medium Voltage (MV) and High Voltage (HV) parts of an electrical power system (which may be at the generation, transmission or distribution parts of the system) the loads are usually balanced. Therefore, in cases where the phases are interconnected using the star connection, the neutral wire can be omitted (which reduces cost and complexity), and there is no access to the neutral point. In cases where the phases are interconnected using the delta connection there is no neutral wire and no access to a neutral point. Preferably, the power supply 12 is a 3-phase balanced power supply.

In typical embodiments, the power supply 12 provides electrical power at MV levels, although the invention is not limited to any particular voltage levels. It is noted that the definition of what voltage levels correspond to LV, MV and HV vary from jurisdiction to jurisdiction. In typical embodiments, the power supply 12 supplies the system 10 with MVAC electrical power, for example in the range 11 kV-66 kV. Typically, the output of the system 10 provides MVDC electrical power, for example in the range 3 kV-50 kV. In typical embodiments, the power supply 12 does not allow, or does not provide, access to a neutral point, e.g. the phases are configured in the star connection but there is no neutral wire, or the phases are configured in the delta connection. In the example of FIG. 1, the phases Va, Vb and Vc of the power supply 12 are connected in the star configuration with a common (or neutral) connection point N, and there is no neutral wire connected to the neutral point N. The power supply 12 provides a respective output line 20, or wire, for each phase, and it is to these outputs 20 that the power converters 16 are connected. In FIG. 1, resistances rₐ, r_{b} and r_{c}, and inductances Lₐ, Lₚ and L_{c} are representative of the resistances and inductances that are inherent in the supply 12.

In FIG. 1, the DC load 14 is represented by a resistance R_{L} and capacitance C_{f} in parallel, although the DC load 14 may take any form depending on the application. For example, the DC load 14 may comprise a DC transmission network, e.g. for transmitting DC power from an offshore renewable energy generation station to shore (e.g. to an electrical grid), or for transmitting DC power to EV charging points.

Each converter 16 has respective first and second input terminals A, B (which may be designated respectively as the positive input terminal and the negative input terminal), and respective first and second output terminals D, C (which may be designated respectively as the positive output terminal and the negative output terminal).

For each phase, the first, or positive, input terminal A of the respective converter 16A, 16B, 16C is connected to the output 20 of the respective phase Va, Vb, Vc. Accordingly, the respective phase current Ia, Ib, Ic flows into the first input terminal A of the respective converter 16A, 16B, 16C. The first input terminals A serve as the power input to the system 10 that is connected to, or is connectable to, the AC power supply 12. The respective second, or negative, input terminals B of each converter 16A, 16B, 16C are connected together.

The respective first and second outputs of the converters 16A, 16B, 16C are connected in parallel with each other to provide the DC output of the system 10. In particular, the respective first, or positive, output terminals D of the converters 16A, 16B, 16C are connected together and provide a first DC output terminal DC+ (which may be designated as the positive output terminal) of the system 10. In use, a respective output current Im1, Im2, Im3 is provided at the first converter output terminals D, and the load current I_{L} provided at the first DC output terminal DC+ is a summation of the respective converter output currents Im1, Im2, Im3. The respective, or negative, second output terminals C of the converters 16A, 16B, 16C are connected together and provide a second DC output terminal DC− (which may be designated as the negative output terminal) of the system 10. The DC output terminals DC+, DC− are connected to the DC load 14.

Advantageously, the system 10 does not require access (connection) to, and so is not connected to, the neutral point N of the power supply 12. In particular, the second input terminals B are not connected to the neutral point N. As such, the interconnected second input terminals B may be described as floating. This arrangement allows a DC bias, or DC offset, to be added to the voltage across the respective input terminals A, B of each converter 16. The DC bias, or DC offset, may be added by the controller 18, in particular by the outer control loop described hereinafter. As a result, the converter output currents Im1, Im2, Im3 each comprises AC current with a DC offset. Because the output currents Im1, Im2, Im3 are added together, the respective AC components of the converter output currents cancel each other out (because of the phase relationship between the 3 phases) such that the load current I_{L} comprises only DC current.

In preferred embodiments, converters 16 are connected in parallel at their output terminals, the respective second input terminals B are connected together (as a floating-point), and the respective first input terminals A are connected to the input voltage (or a respective input phase voltage). The controller 18 is configured to manipulate the voltage across the input terminals A, B of each converter 16 such that it comprises a dc-offset AC waveform. The controller 18 is configured to keep the line voltages between phases as an AC voltage without any additional line transformer. The controller 18 is configured to keep the input current to the first input terminal A of each converter 16 in phase with the input phase voltage. The voltage on the output terminals C, D of each converter 16, is the same voltage for the converters 16 (as they are connected in parallel at their outputs) and comprises pure DC voltage.

In preferred embodiments, each power converter 16 is a switched-mode power converter, preferably a switched-mode DC to DC converter, i.e. it has the circuit topology of a switched-mode DC to DC converter, although as is described in more detail hereinafter it is controlled to perform AC to DC conversion. Advantageously, the power converter 16 does not include a rectifier, and may therefore be described as bridgeless. Preferably, the power converters 16 are identical.

Switched-mode DC to DC converters convert DC voltage from one level to another, which may be higher or lower. DC to DC converters comprise at least one controllable switch (typically comprising a transistor, e.g. a MOSFET, IGBT or BJT transistor) and at least one (typically at least two) energy storage components. In use, the (or each) switch is controlled to store input energy in the relevant storage component(s) and then to release the stored energy from the relevant storage component(s) to the output. This may be achieved by controlling the duty cycle of the, or each, switch. Depending on the circuit topology of the converter and/or on how the, or each, switch is controlled, the voltage level at the output may be higher, lower or the same as the input voltage level. Depending on the circuit topology, the polarity of the output voltage may be the same as the polarity of the input voltage, or may be inverted with respect to the input voltage. The energy storage components may be magnetic field storage components (inductors, transformers) or electric field storage components (capacitors). If galvanic isolation is required between the input and the output, then a transformer may be provided between the input and output sides of the converter. Such converters may be referred to as isolated DC to DC converters.

The power converter 16 may have a variety of different topologies, including known DC to DC converter topologies, and may be isolating or non-isolating, inverting or non-inverting as desired or depending on the requirements of the application. The converter 16 is preferably a bidirectional converter. The converter 16 preferably has first and second controllable switches, one being provided at the input side of the converter 16 and the other being provided at the output side of the converter 16. Preferably, the converter 16 comprises at least one inductor and at least one capacitor as storage components.

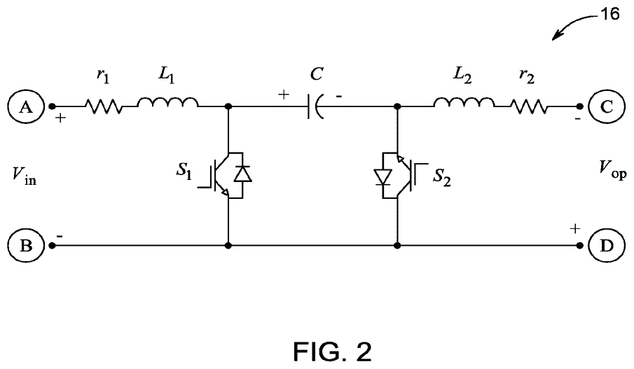

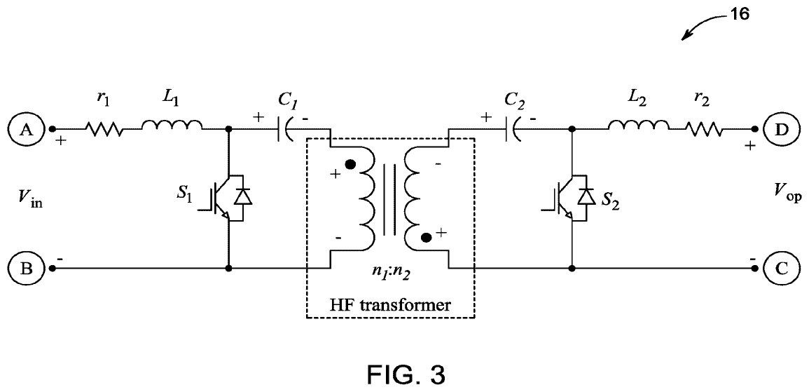

FIG. 2 shows a preferred topology for the converter 16. Converters with the topology shown in FIG. 2 are of a type known as Cuk converters. In particular, FIG. 2 shows a bidirectional non-isolated Cuk converter, with a preferred modification whereby it includes an output side controllable switch S2 rather than a diode. FIG. 3 shows an isolated version of the topology of FIG. 2, which may be alternatively be used in embodiments where galvanic isolation is required. The invention is not limited to use with Cuk converter topologies. By way of example, other converter topologies that may be used include types known as Boost-buck converters, SEPIC converters and variations thereof, preferably in a bidirectional form, and which may be isolating or non-isolating, inverting or non-inverting.

Referring to FIG. 2, the preferred converter 16 has an input comprising the first and second input terminals A, B and an output comprising the first and second output terminals D, C. It is noted that in this embodiment, the polarity of the voltage Vop at the output is inverted with respect to the polarity of the voltage Vin at the input. A first inductance L1 is connected to the input, preferably in series with the first, or positive, input terminal A. The inductance L1 preferably comprises a single inductor but may alternatively be implemented as one or more inductor. A second inductance L2 is connected to the output, preferably in series with the second, or negative, output terminal C. The inductance L2 preferably comprises a single inductor but may alternatively be implemented as one or more inductor. FIG. 2 shows a respective resistance r1, r2 in series with each inductance L1, L2, which are intended to represent parasitic resistance. A capacitance C is provided between the input and output of the converter 16, preferably in series with the first input terminal A and the second output terminal C. The capacitance C preferably comprises a single capacitor but may alternatively be implemented as one or more capacitor. The capacitance C is preferably connected in series between the inductances L1, L2. A first controllable switch S1 is provided at the input side of the converter 16, preferably being connected in parallel with the input terminals A, B, i.e. between the positive and negative circuit branches at the input side of the converter 16. Preferably, the switch S1 is provided between the inductance L1 and the capacitance C1, preferably being connected to the positive branch of the input side between the inductance L1 and the capacitance C. A second controllable switch S2 is provided at the output side of the converter 16, preferably being connected in parallel with the input terminals D, C, i.e. between the positive and negative circuit branches at the output side of the converter 16. Preferably, the switch S2 is provided between the inductance L2 and the capacitance C, preferably being connected to the negative branch of the input side between the inductance L2 and the capacitance C. The switches S1, S2 are controllable in that they can be operated between ON (or conducting) and OFF (or non-conducting) states. Typically, the switch S1, S2 comprises one or more transistor, e.g. a MOSFET, IGBT or BJT transistor. In alternative embodiments (not illustrated), the second controllable switch S2 may be replaced by a diode, for example in accordance with the topology of a standard Cuk converter. The typical arrangement is such that the diode is forward biased when the first switch S1 is OFF and reverse biased with the first switch S1 is ON.

In use, the switches S1, S2 are switched on and off in order to store energy from the input voltage Vin in the first inductance L1 and capacitance C (typically when S1 is OFF and S2 is ON), and to release the stored energy as the output voltage Vop (typically when S1 is ON and S2 is OFF). In order to obtain the desired voltage conversion, the switches S1, S2 are controlled using a preferred control method described hereinafter.

In preferred embodiments, the converter 16 is configured to receive continuous input current and to provide continuous output current. Preferably, the converter 16 is configured to allow voltage and or current levels to be stepped up or stepped down. In preferred embodiments, the converter 16 is a current source converter. In preferred embodiments, each converter 16 includes an inductance/inductor in series with at least one of, usually only one of, its output terminals.

The converter 16 of FIG. 2 has a non-isolating topology. FIG. 3 shows an alternative isolating topology for the converter 16. The topology of FIG. 3 is similar to the topology of FIG. 2 and the same or similar description applies as would be apparent to a skilled person. However, a transformer, preferably a high frequency (HF) transformer, is provided between the input side and output side of the converter 16 to provide galvanic isolation between the input and output. In addition, a respective capacitance C1, C2 is provided in the input side and the output side, typically in series with the transformer.

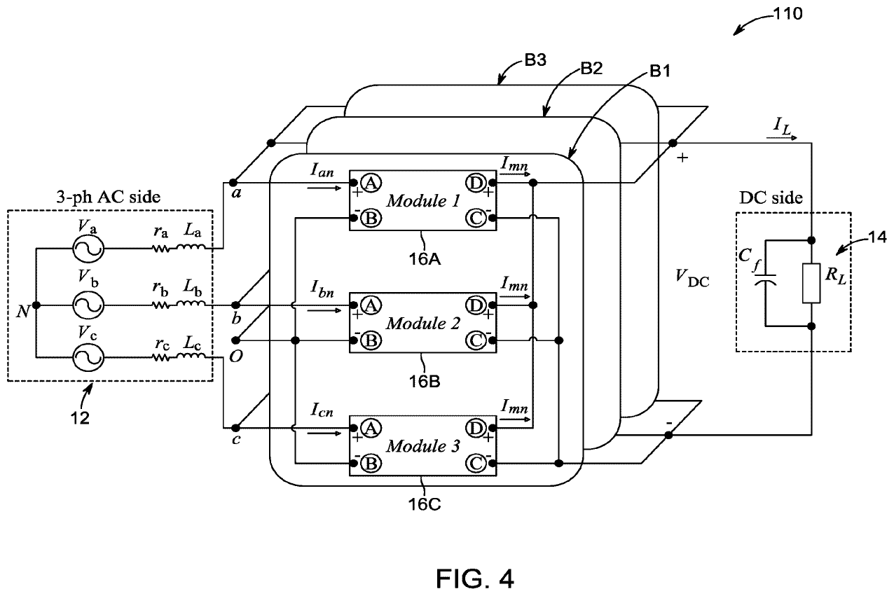

In the embodiment of FIG. 1, a respective instance (16A, 16B, 16C) of the converter 16 is provided for each phase of the power supply 12. In particular there is a single instance of the converter 16 per phase. In alternative embodiments, a plurality of instances of the converter 16 may be provided for each phase of the power supply. FIG. 4 shows an alternative embodiment of the system, indicated as 110, in which a plurality of instances of the converter 16 are provided for each phase of the power supply 12. The converters 16 for each phase are connected in parallel with each other, and are connected between the input and output of the system 110 in the same manner described for the converters 16A, 16B, 16C of FIG. 1. In the example of FIG. 4, three instances of the converter 16 are provided per phase, as is represented by the three parallel banks B1, B2, B3 of converters 16 (where banks B2 and B3 are the same as bank B1). More generally, there may be two or more such parallel banks of converters 16. Increasing the number of instances of converter 16 provided per phase, increases the amount of power that can be converted by the system 110. For example, if the current and the voltage of the supply exceed the capability of one instance of the converter 16, multiple instances of the converter 16 can be connected in parallel for each phase.

FIG. 5 shows the system 10 of FIG. 1 in which each instance of the converter 16 has the topology shown in FIG. 2, and also shows the system controller 18 and sensors for measuring the output voltage (Vdc), the input voltages (Vab, Vbc) and the input currents (Ia, Ib). The controller 18 is configured to receive measured values for the input currents, input voltages and output voltage from the relevant sensors and to generate a respective control signal (S11, S21, S12, S22, S13, S23) for controlling the operation of the respective switches S1, S2 of each instance of the converter 16. In the example of FIG. 5, there is one converter 16 per phase. In embodiments where there is more than one converter 16 per phase, the same control signals can be provided to each converter 16 of each phase.

In the example of FIG. 5, a first voltage sensor VS1 is provided for measuring the output voltage Vdc. A second voltage sensor VS2 is provided for measuring the input line voltage between phases Va and Vb. A third voltage sensor VS3 is provided for measuring the input line voltage between phases Vb and Vc. These measured voltages may be used to calculate the input line voltage between phases Va and Vc in conventional manner. It will be understood that other arrangements of voltage sensor(s) may be used to measure the input line voltages and/or the output voltage, or the respective voltages may be determined by any other conventional means. In the preferred embodiment, the input line voltages Vab, Vbc, Vac are used to determine the input phase voltages Va, Vb, Vc, preferably a respective normalized or per-unit version of the input phase voltages Va, Vb, Vc. More generally, the system 10, 100 includes means for measuring or calculating the line voltages Vab, Vbc, Vac of the supply 12, and/or means for measuring, calculating or otherwise determining the input phase voltages Va, Vb, Vc.

In the example of FIG. 5, a first current sensor CS1 is provided for measuring the input current Ia of phase Va. A second current sensor CS2 is provided for measuring the input current Ib of phase Vb. These measured currents Ia, Ib may be used to determine the input current Ic in conventional manner. It will be understood that other arrangements of current sensors may be used to measure the input line voltages. More generally, the system 10, 110 includes means for measuring, calculating or otherwise determining the input phase currents Ia, Ib, Ic.

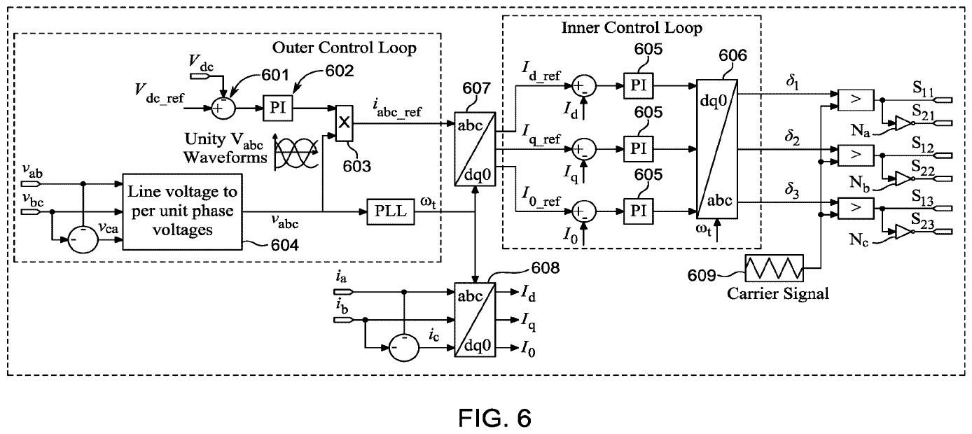

A preferred method of controlling the operation of the system 10, 110 is now described with particular reference to FIGS. 5 and 6. The controller 18 is configured to implement the control method by controlling the operation of the switches S1, S2 of the converters 16 to control the output voltage Vdc and the input phase currents Ia, Ib, Ic based on determined actual values of the output voltage Vdc and of the input phase currents Ia, Ib, Ic, i.e. implementing closed-loop feedback control.

FIG. 6 illustrates the preferred controller and control method. The preferred controller/method may be said to comprise a first (or outer) closed-loop feedback control loop and a second (or inner) closed loop feedback control loop. The outer control loop is configured to control the DC output voltage Vdc, in particular to regulate the output voltage Vdc with respect to a desired voltage level Vdc_ref, i.e. to cause the actual output voltage level to be maintained at the desired voltage level. The inner control loop is configured to control the actual input phase currents Ia, Ib, Ic in accordance with respective reference, or target, input phase currents. Advantageously, the inner loop controls the three-phase input currents Ia, Ib, Ic to be sinusoidal and in-phase with the respective phase of the three-phase voltage supply Va, Vb, Vc.

The inner control loop is also configured to generate the control signals (S₁ⱼ and S₂ⱼ where j ∈ {1,2,3}) for the switches S1, S2 of the converters 16, which in preferred embodiments involves generating a respective instantaneous duty ratio (δᵢ(t)), or duty cycle, for controlling the switches.

Each instantaneous duty ratio is variable with time and depends on the shape, frequency and amplitude of the DC output and AC input waveforms. The respective duty ratio, or duty cycle, determines when the respective switch is switched on and off.

As is described in more detail below, the outer control loop is configured to generate respective reference phase currents Iabc_ref based on the difference between the actual output voltage level Vdc and the desired voltage level Vdc_ref. The inner control loop generates the switch control signals based on the difference between the actual input phase currents Ia, Ib, Ic and the respective reference input phase currents.

Accordingly, to achieve the desired output voltage Vdc, the input phase currents Ia, Ib, Ic are controlled depending on the actual output voltage value. In particular, the input phase currents Ia, Ib, Ic are controlled to match the respective reference input phase currents, the reference phase currents being derived from the difference between the actual output voltage level Vdc and the desired voltage level Vdc_ref.

The outer control loop is configured to regulate the DC output voltage Vdc at the desired, or target, level Vdc_ref. In preferred embodiments, to achieve this, the outer control loop is configured to calculate a respective peak (or target) value for the reference input phase currents labc_ref. The peak values may be determined depending on the difference between the measured value of Vdc with the reference value Vdc_ref. In the outer control loop of FIG. 6, the measured output voltage Vdc is compared to the reference signal Vdc_ref (as indicated at 601) and the resultant error is tuned to be zero by a controller 602, for example a proportional integral (PI) controller. The output of the controller 602 may be used as the peak value for the reference input phase currents. The same peak value may be used as the reference value for each reference input phase current.

Advantageously, the preferred control method controls the input phase currents Ia, Ib, Ic to be in phase with the respective input phase voltages Va, Vb, Vc to achieve a unity power factor. This may be achieved by causing the respective reference input phase currents Iabc_ref to be in phase with the respective input phase voltages Va, Vb, Vc. To achieve this, a respective signal having a waveform corresponding to the respective input phase voltage Va, Vb, Vc may be multiplied with, or otherwise combined with, the peak current value for the reference input phase currents (as indicated at 603 in FIG. 6) to produce respective reference input phase currents Iabc_ref with a waveform that is in phase with the respective input phase voltage Va, Vb, Vc.

In the illustrated embodiment, to create the respective waveforms that are combined with the peak current value to produce the input reference currents Iabc_ref, the voltage sensors VS1, VS2 are used to determine the three-phase line voltages Vab, Vbc, Vca, which are then converted into the three phase voltages Va, Vb, Vc (as indicated at 604 in FIG. 6). Preferably, the phase voltages Va, Vb, Vc are converted to per unit quantities (i.e. a sine wave with peak value of 1). The three phase per unit signals have a waveform that is a replica of the respective phase voltage Va, Vb, Vc. The output of the DC voltage controller 602 is multiplied by the three-phase per unit waveforms to create the input reference currents Iabc_ref.

To achieve unity power factor, the input phase currents Ia, Ib, Ic are controlled to match the input reference currents Iabc_ref and thus to be in phase with the respective input phase voltage Va, Vb, Vc. In addition, the magnitude, or peak value, of the input phase currents Ia, Ib, Ic are controlled to match the input reference currents Iabc_ref and thus to depend on the desired output DC voltage Vdc_ref, or on the difference between Vdc_ref and the actual output voltage value.

In preferred embodiments, the inner control loop forces the three-phase input currents Ia, Ib, Ic to follow the respective reference input phase current Iabc_ref. To achieve this it is preferred to use a phased locked loop (PLL) algorithm to extract the rotating angle (ωₜ) from the abc reference frame and to use the angle in a synchronous reference frame (direct-quadrature-zero (dq0)) algorithm to convert both the reference input currents Iabc_ref and the measured three-phase input currents Ia, Ib, Ic to de quantities (607 and 608 in FIG. 6). This simplifies the operation of the inner control loop, in particular making PI control, or other conventional control, possible. In the preferred embodiment, the inner control loop has a respective controller 605 (preferably a PI controller, although other controller such as PID or PR controllers may alternatively be used) for each phase, the controllers 605 being tuned to provide zero steady-state error tracking for the three-phase input currents with respect to the respective reference input currents. The controllers 605 generate the desired modulating signals in the synchronous reference frame, which are then converted back to the stationary frame (at converter 606 in FIG. 1) to produce the duty ratios, δⱼ, for controlling the converter switches S₁ⱼ and S₂ⱼ. where, j is the converter number (j ∈ {1, 2, 3}).

In the illustrated embodiment, the current sensors CS1, CS2 are used to measure the actual input phase currents Ia, Ib, Ic that are to be controlled. The conversion from the abc reference frame to the dq0 reference frame is performed since it is convenient to use PI controllers, and since the currents are sinusoidal. Hence the AC sinusoidal waves are translated to equivalent DC quantities to allow PI controllers 605 to be used. This conversion may be achieved by generating the three-phase actual angle (ωₜ) by applying a phase-locked loop (PLL) algorithm to the measured three-phase voltages Va, Vb, Vc. The controllers 605 are used after converting both the measured and the reference currents to the dq0 reference and then the errors for each are tuned to be zero. The output from the current controllers 605 provide the modulating signals for the converter switches S1, S2 (after transformation back to the abc reference frame). The three-phase modulating signals are obtained (δ_{abc}) and may be compared with a carrier signal 609 to provide the ON/OFF command for the respective switches S1, S2 in each converter 16. A respective switch control signal δa, δb, δc is provided for each phase of the supply 12 and therefore for each converter 16A, 16B, 16C. In embodiments where each converter 16 has the first and second switches S1, S2, the switches are controlled such that when one of the switches S1, S2 is ON, the other of the switches S2, S1 is OFF and vice versa. Conveniently, the respective control signal is used to control one of the switches S1, S2 and an inverted version of the respective control signal is used to control the other switch S2, S1. In the embodiment of FIG. 6, this is illustrated by the respective logic inverters, or NOT gates Na, Nb, Nc. In preferred embodiments the respective control signal δa, δb, δc controls the respective input side switch S1 and the corresponding inverted control signal controls the respective output side switch S2.

The three phase power supply 12 is balanced and supplies a respective phase current input to each converter 16. Because the power supply is balanced, the sum of the phase currents is zero. By controlling the respective switches S1, S2, the controller 18 is configured to cause the converters 16A, 16B, 16C to be provided with a respective input phase current Ia, Ib, Ic, the currents being balanced currents and providing unity power factor. By controlling the respective switches S1, S2, the controller 18 is configured to add a DC offset to the voltage across the respective input terminals A, B of each converter 16. When the output currents Im1, Im2, Im3 of the converters 16A, 16B, 16C are combined at the output of the system 10, 110, the respective AC parts of the current waveforms cancel each other out (because of the phase relationship between them) leaving only DC current and therefore a DC output voltage. The DC offsets of the output currents Im1, Im2, Im3 add together, i.e. are summed, to provide the output current I_{L}.

It will be apparent from the foregoing that the controller 18 determines the output voltage Vdc and the input phase currents Ia, Ib, Ic in order to generate the control signals for controlling the switches S1, S2 of each converter 16. By controlling the switches S1, S2, the controller 18 is able to control the input phase currents la, Ib, Ic and/or the voltage across the input terminals A, B of each converter 16 as required. In preferred embodiments, the controller 18 is configured to control the respective switches S1, S2 in order that the respective input phase currents Ia, Ib, Ic is in phase with the respective input phase voltage. The preferred controller 18 is configured to control the respective switches S1, S2 such that the respective DC offset is added to the voltage across the input terminals A, B of the respective converter 16. Each converter 16 has a transfer function defining the relationship between its output voltage and its input voltage. The transfer function is dependent on how the switches S1, S2 are controlled, i.e. dependent on the control signals or duty ratio. Therefore, by controlling the switches S1, S2, e.g. by controlling their duty ratio or duty cycle, the controller 18 is able to control the transfer function of the respective converter 16. Accordingly, the controller 18 is able to control output voltage and input current. This is facilitated by the “floating” nature of the interconnected terminals B of the converters 16, which allows a DC offset to be added at the terminals AB.

Advantageously, the converters 16 are required to store less energy than is required in conventional AC to DC conversion systems and so there is no need to use electrolytic capacitors.

The embodiments described above are intended for use with a three phase supply 12, wherein the input phase currents are provided to a respective converter 16 (or more than one respective converter 16) and are controlled collectively to perform AC to DC conversion.

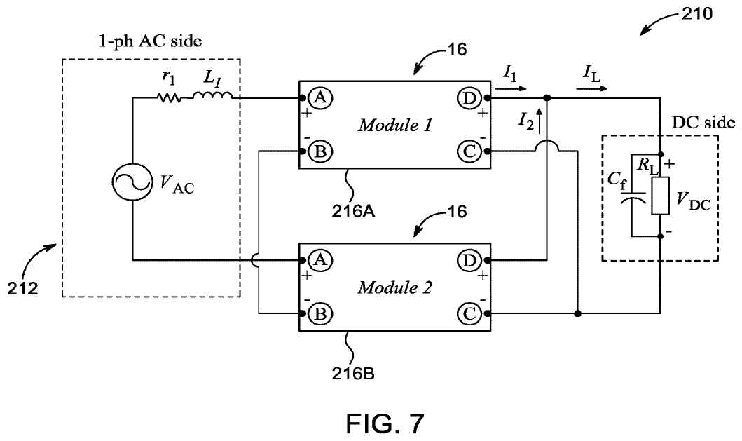

FIGS. 7 to 9 illustrate an embodiment of the AC to DC power conversion system 210 which is configured to perform AC to DC conversion on a single phase AC input supply 212. The embodiment of FIGS. 7 to 9 is similar to the embodiments of FIGS. 1 to 6 with like numerals being used to denote like parts and the same or similar description applying as would be apparent to a skilled person. In particular the converters 16 may be the same as described above in relation to FIGS. 1 to 6. However, in this embodiment, the positive terminal of the single phase supply V_{AC} is connected to the positive input A of a first instance 216A of the converter 16, and the negative terminal of the single phase supply is connected to the positive input A of a second instance 216B of the converter 16. As such, the single phase input current positive direction is connected to the positive input of converter 216A, while the current negative direction is connected to the positive input of the converter 216B. The respective negative inputs B of the converters 216A, 216B are connected together. The negative inputs B may be said to be floating in that they are connected together and not to any external point. The outputs of the converters 216A, 216B are connected in parallel with each other to provide the DC output V_{DC}. In particular, the positive output terminals D are connected together and provide the positive DC output terminal, the negative output terminals C are connected together and provide the negative DC output terminal. This arrangement causes the AC parts of the input current to cancel each other out at the output, leaving only DC current and therefore a DC output voltage. It is noted that in the three phase embodiment, each converter 16A, 16B, 16C receives a respective phase input current and, because of the phase relationship between phases, the respective output currents can be added together with the AC components cancelling out to leave only DC current. In contrast, in the single phase embodiment, to remove the AC components of the output currents, each converter 216A, 216B is provided with the same input current but in reverse directions.

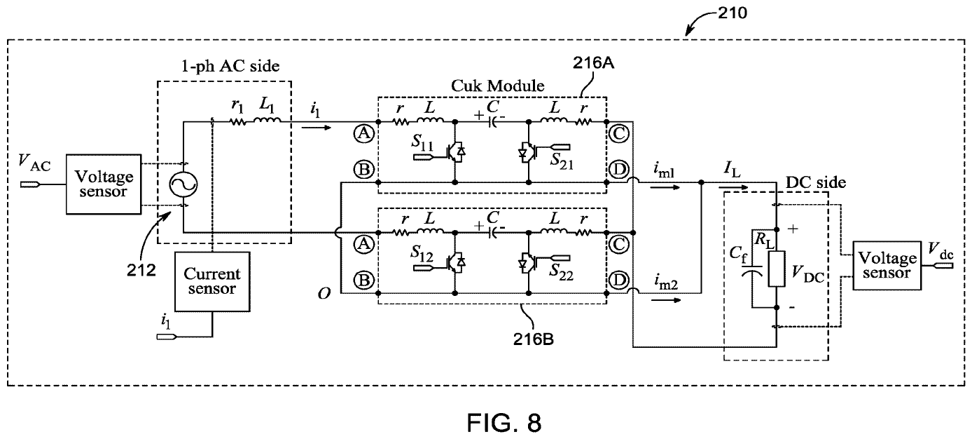

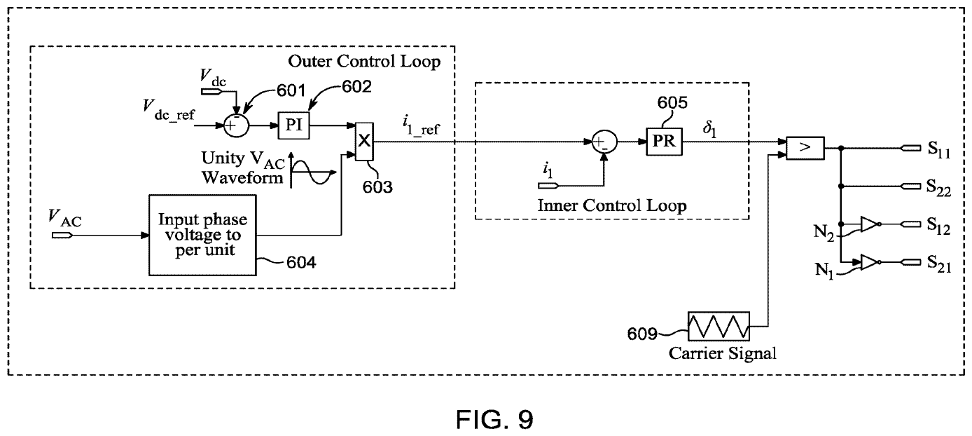

The preferred control method is similar to that described above in that the switches S1, S2 (or just S1 if S2 is replaced by a diode) of each converter 16 are controlled to generate a controlled input current and controlled output DC voltage. As can be seen from FIG. 8, only one current sensor is provided to measure the single phase input current I₁, and one voltage sensor is provided to measure the input voltage V_{AC}. In the control scheme shown in FIG. 9, in the inner control loop a proportional Resonant (PR) controller is preferably used instead of a PI controller for simplicity, although PI or PID control may alternatively be used. Also, the conversion between the abc reference frame and the dq0 reference frame is not required. Otherwise, the outer control loop generates a reference input current signal I_{1_ref} based on the measured output voltage V_{DC} and the reference output voltage Vdc_ref as before, wherein the reference input current I_{1_ref} has the same waveform and is in phase with the input voltage V_{AC}. The inner control loop controls the input current I₁ to match the reference input current I_{1_ref}, and produces an output for controlling the converter switches accordingly. The output from the current controller 605 provides the modulating signal for the converter switches S1, S2. The modulating signal δ1 is obtained and may be compared with a carrier signal 609 to provide the ON/OFF command for the respective switches S1, S2 in each converter 16. In embodiments where each converter 16 has the first and second switches S1, S2, the switches are controlled such that when one of the switches S1, S2 is ON, the other of the switches S2, S1 is OFF and vice versa. Conveniently, the respective control signal is used to control one of the switches S1, S2 and an inverted version of the respective control signal is used to control the other switch S2, S1. In the embodiment of FIG. 6, this is illustrated by the respective logic inverters, or NOT gates N1, N2. In preferred embodiments the respective control signal δ1 controls the respective input side switch S1 and the corresponding inverted control signal controls the respective output side switch S2.

In the preferred embodiments described above, each converter 16 has first and second controllable switches S1, S2. This is a preferred arrangement that allows the controller 18 to track the reference current relatively efficiently. In alternative embodiments however, the second switch S2 may be replaced with a corresponding diode, which is not controllable between ON and OFF states. In such embodiments the same control methods as described above may be used except that the control signals (S21, S22, S23 for the embodiment of FIGS. 5 and 6, and S12 and S21 for the embodiment of FIGS. 8 and 9) that are intended for the second switch S2 (now replaced by the diode) can be either not calculated or ignored.

The invention is not limited to the embodiment(s) described herein but can be amended or modified without departing from the scope of the present invention.

1. An AC to DC power conversion system for converting AC power from an AC power supply to DC power, the conversion system comprising:
a plurality of switched-mode DC to DC converters, each DC to DC converter comprising:
an input comprising a first input terminal for receiving current from said AC power supply, and a second input terminal;
an output comprising a first output terminal and a second output terminal;
at least one energy storage component; and
at least one controllable switch for controlling operation of the converter,
wherein the respective second input terminal of each converter are connected together, and the respective output terminals of each converter are connected in parallel to provide a DC output;
a controller for controlling operation of said at least one controllable switch of each DC to DC converter;
means for determining a DC voltage at said DC output;
means for determining at least one AC voltage signal received from said AC power supply, said at least one AC voltage signal comprising a single-phase voltage signal or a multi-phase voltage signal; and
means for determining AC current at the first input terminal of at least one of said converters,
wherein for each of said converters said controller is configured to
generate a reference AC current signal depending on the determined DC voltage and a reference DC voltage, said reference AC current signal being in phase with said single-phase voltage signal or a respective phase of said multi-phase voltage signal, and
control the operation of said at least one controllable switch to cause the AC current at the first input terminal to match the reference AC current signal.

2. The system of claim 1, wherein each DC to DC converter comprises a current source DC to DC converter.

3. The system of claim 1, wherein said at least one energy storage component comprises at least one inductor connected in series with said first input terminal, and at least one capacitor connected in series with said at least one inductor.

4. The system of claim 1, wherein said at least one energy storage component comprises at least one inductor connected in series with said first output terminal or said second output terminal, and at least one capacitor in series with said at least one inductor.

5. The system of claim 1, wherein said at least one energy storage component comprises at least one capacitor connected in series with said first input terminal, and with said first output terminal or said second output terminal, or at least one capacitor connected in parallel with the converter output.

6. The system of claim 1, wherein each converter includes a transformer connected between the input and the output to galvanically isolate the input and the output, and wherein a respective capacitor is connected to each side of the transformer in series with the transformer.

7. The system of claim 1, wherein each DC to DC converter comprises at least one first inductor connected in series with said first input terminal, at least one second inductor connected in series with said first output terminal or said second output terminal, and at least one capacitor connected in series between said at least one first inductor and said at least one second inductor.

8. The system of claim 1, wherein said at least one controllable switch comprises a first controllable switch and a second controllable switch, or a first controllable switch and a diode, and wherein said-first controllable switch and or second controllable switch, or said first controllable switch and said diode, are connected in parallel with said input and said output, and wherein said first controllable switch is connected to an input side of said converter, and said second controllable switch, or said diode, is connected to an output side of said converter.

9. The system of claim 8, wherein each DC to DC converter comprises at least one first inductor connected in series with said first input terminal, at least one second inductor connected in series with said first output terminal or said second output terminal, and at least one capacitor connected in series between said at least one first inductor and said at least one second inductor, and wherein said first controllable switch is connected in parallel with said input between said at least one first conductor and said at least one capacitor, and wherein said second controllable switch, or said diode, is connected in parallel with said output between said at least one capacitor and said at least one second conductor.

10. The system of claim 1, wherein each DC to DC converter has a Cuk converter topology and/or wherein each DC to DC converter is a bidirectional DC to DC converter.

11. (canceled)

12. The system of claim 1, wherein said controller is configured to generate said reference AC current signal depending on the difference between said determined DC voltage and said reference DC voltage, and wherein said controller is configured to generate said reference AC current signal by implementing a closed feedback control loop configured to cause said determined DC voltage to match said reference DC voltage, and by using the output of said feedback control loop to generate said reference AC current signal, and wherein said closed feedback control loop is implemented using proportional-integral (PI) control.

13. (canceled)

14. The system of claim 1, wherein said controller is configured to determine a reference current value depending on the determined DC voltage and the reference DC voltage, and to generate said reference AC current signal from said reference current value, and wherein said controller is configured to generate said reference AC current signal depending on the difference between said determined DC voltage and said reference DC voltage and said controller is configured to determine said reference current value depending on the difference between said determined DC voltage and said reference DC voltage, or wherein said controller is configured to generate said reference AC current signal by implementing a closed feedback control loop configured to cause said determined DC voltage to match said reference DC voltage, and by using the output of said feedback control loop to generate said reference AC current signal, and wherein said closed feedback control loop is implemented using proportional-integral (PI) control and said controller is configured to determine said reference current value from the output of said feedback control loop.

15. (canceled)

16. The system of claim 1, wherein said system further includes means for causing said reference AC current signal to be in phase with the single-phase AC voltage signal or with a respective phase of the multi-phase AC voltage signal.

17. The system of claim 16, wherein said controller is configured to determine a reference current value depending on the determined DC voltage and the reference DC voltage, and to generate said reference AC current signal from said reference current value, and wherein said means for causing said reference AC current signal to be in phase with the single-phase AC voltage signal or with a respective phase of the multi-phase AC voltage signal comprises means for combining said reference current value with a respective per unit version of said single-phase AC voltage signal or with said respective phase of the multi-phase AC voltage signal, or other respective reference signal derived from said single-phase AC voltage signal or from said respective phase of the multi-phase AC voltage signal, and having a waveform that matches the waveform of the single-phase AC voltage signal or of the respective phase of the multi-phase AC voltage signal.

18. The system of claim 1, wherein said controller is configured to control the operation of said at least one controllable switch to cause said AC current at the first input terminal to match said reference AC current signal depending on the difference between said determined AC current and the respective reference AC current signal, and wherein said controller is configured to implement a closed feedback control loop configured to cause said determined AC current to match the reference AC current signal, and to use the output of said feedback control loop to control said at least one controllable switch, and wherein said closed feedback control loop is implemented using proportional-integral (PI) control or proportional-resonant (PR) control.

19. (canceled)

20. The system of claim 1, wherein said at least one controllable switch comprises first and second controllable switches, and wherein said controller is configured to control said first and second controllable switches such that when either one of said first and second controllable switches is on, the other of said first and second controllable switches is off.

21. The system of claim 1, wherein said at least one controllable switch comprises one controllable switch, the converter further including a diode connected in parallel with the controllable switch, the configuration being such that when said controllable switch is on the diode is reverse biased, and when the controllable switch is off the diode is forward biased.

22. The system of claim 1, wherein said AC power supply comprises a multi-phase power supply and said at least one AC voltage signal comprises multiple AC voltage phases, wherein said plurality of DC to DC converters comprises at least one respective DC to DC converter for each phase of the power supply, wherein the respective first input terminal of said at least one respective converter is arranged to receive AC current from the respective phase of the power supply, wherein said means for determining AC current comprises means for determining AC current at the first input terminal of each of said at least one respective converters, said means for determining at least one AC voltage signal comprises means for determining a respective AC voltage signal for each phase, and wherein the controller is configured to generate a respective reference AC current signal for each phase of the power supply, and wherein, said at least one respective converter comprises a plurality of said converters connected in parallel with each other, and wherein said means for determining at least one AC voltage signal comprises means for determining line voltages for said multi-phase supply, and means for determining a respective phase voltage comprises a respective per-unit phase voltage, for each phase from the line voltages.

23. (canceled)

24. The system of claim 1, wherein said AC power supply comprises a single-phase power supply and said at least one AC voltage comprises a single phase AC voltage, wherein said plurality of DC to DC converters comprises at least one first DC to DC converter and at least one second DC to DC converter, the first input terminal of said at least one first DC to DC converter being connected to or connectable to a positive terminal of said AC power supply, and the first input terminal of said at least one second DC to DC converter being connected to or connectable to the negative terminal of said AC power supply, and wherein said at least one first DC to DC converter comprises a plurality of first DC to DC converters connected in parallel with each other, and said at least one second DC to DC converter comprises a plurality of second DC to DC converters connected in parallel with each other.

25. A method of converting AC power from an AC power supply to DC power in a power conversion system comprising:
a plurality of switched-mode DC to DC converters, each DC to DC converter comprising:
an input comprising a first input terminal for receiving current from said AC power supply, and a second input terminal;
an output comprising a first output terminal and a second output terminal;
at least one energy storage component; and
at least one controllable switch for controlling operation of the converter,
wherein the respective second input terminal of each converter are connected together, and the respective output terminals of each converter are connected in parallel to provide a DC output, the method comprising:
determining a DC voltage at said DC output;
determining at least one AC voltage signal received from said AC power supply, said at least one AC voltage signal comprising a single-phase voltage signal or a multi-phase voltage signal;
determining AC current at the first input terminal of at least one of said converters;
generating, for each converter, a reference AC current signal depending on the determined DC voltage and a reference DC voltage, said reference AC current signal being in phase with said single-phase voltage signal or a respective phase of said multi-phase voltage signal; and
controlling the operation of said at least one controllable switch of each converter to cause the AC current at the first input terminal to match the reference AC current signal.
